(19) United States
(12) Patent Application Publication
(10) Pub. No.: US 2019/0057210 A1
(43) Pub. Date: Feb. 21, 2019

(54) USER DETAILS BASED PASSWORD POLICY

(71) Applicant: CA, Inc., New York, NY (US)

(72) Inventors: Abhijeet Hanumantrao AELKATWAD, Latur (IN); Yashwant Ramkishan SAWANT, Parbhani (IN); Mehak BANSAL, Faridabad (IN); Rahul Gurudas DHAVALIKAR, Bangalore (IN)

(73) Assignee: CA, Inc.

(21) Appl. No.: 15/680,888

(22) Filed: Aug. 18, 2017

(51) Int. Cl. G06F 21/46; G06F 21/31

(52) U.S. Cl. CPC G06F 21/46; G06F 21/31

(57) ABSTRACT

A method of providing a dynamic user details-based password policy includes steps of receiving a first set of information from a user and in response to receiving the first set of information, determining a first sensitivity score. The method also includes determining whether the first sensitivity score is greater than a baseline sensitivity score. The baseline sensitivity score may be based on historic account information from the user and requirements for an historic account password are based on the baseline sensitivity score. The method further includes in response to determining that the first sensitivity score is greater than the baseline sensitivity score, prompting the user to modify the historic account password to create a first password. Requirements for the first password are based on the first sensitivity score and require increased strength of the first password relative to the historic account password.

### BACKGROUND

The present disclosure relates to dynamic password policy changes based on the sensitivity of user information.

In general, most accounts, from online bank accounts to Amazon accounts, are protected by password. Typically, a policy is provided to the user who creates the account with requirements that the password must meet, e.g., the password should have at least 8 characters or the password should have at least 1 number. These policies are static and do not consider the sensitivity of the information stored in the account. A user has to follow a strict policy even when there is less or no sensitive data within the account.

### BRIEF SUMMARY

According to an aspect of the present disclosure, a method may include the steps of receiving a first set of information from a user; in response to receiving the first set of information, determining a first sensitivity score; determining whether the first sensitivity score is greater than a baseline sensitivity score, wherein the baseline sensitivity score is based on historic account information from the user and wherein requirements for an historic account password are based on the baseline sensitivity score; and in response to determining that the first sensitivity score is greater than the baseline sensitivity score, prompting the user to modify the historic account password to create a first password, wherein requirements for the first password are based on the first sensitivity score and require increased strength of the first password relative to the historic account password.

According to another aspect of the present disclosure, a non-transitory computer-readable storage medium may have instructions stored thereon that may be executable by a computing system to: receive a first set of information from a user; determine a first sensitivity score; prompt the user to create a first password, wherein requirements for the first password are based on the first sensitivity score; receive a second set of information from the user; in response to receiving the second set of information, determine a second sensitivity score; determine whether the second sensitivity score is greater than the first sensitivity score; and in response to determining that the second sensitivity score is greater than the first sensitivity score, prompt the user to modify the first password to create a second password, wherein requirements for the second password are based on the second sensitivity score and require increased strength of the second password relative to the first password.

According to another aspect of the present disclosure, a computer system may include a server configured to: receive a first set of information from a user; determine a first sensitivity score; prompt the user to create a first password, wherein requirements for the first password are based on the determined first sensitivity score; receive a second set of information from the user; in response to receiving the second set of information, determine a second sensitivity score; determine whether the second sensitivity score is greater than the first sensitivity score; and in response to determining that the second sensitivity score is greater than the first sensitivity score, prompt the user to modify the first password to create a second password, wherein requirements for the second password are based on the second sensitivity score and require increased strength of the second password relative to the first password

Other objects, features, and advantages will be apparent to persons of ordinary skill in the art from the following detailed description and the accompanying drawings.

### BRIEF DESCRIPTION OF THE DRAWINGS

Aspects of the present disclosure are illustrated by way of example and are not limited by the accompanying figures with like references indicating like elements.

FIG. 1 illustrates a schematic representation of examples of sensitivity score bands.

FIG. 2 illustrates a schematic representation of examples of sensitivity scores and levels assigned to various categories of information.

FIG. 3 illustrates a flow chart for an embodiment of providing a dynamic user-details based password policy.

FIG. 4 illustrates a flow chart for an embodiment of providing a dynamic user-details based password policy.

FIG. 5 illustrates a flow chart for an embodiment of providing a dynamic user-details based password policy.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or in a combined software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would comprise the following: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. In the context of this document, a computer readable storage medium may be any tangible medium able to contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take a variety of forms comprising, but not limited to, electro-magnetic, optical, or a suitable combination thereof. A computer readable signal medium may be a computer readable medium that is not a computer readable storage medium and that is able to communicate, propagate, or transport a program for use by or in connection with an instruction execution system, apparatus, or device. Program code embodied on a computer readable signal medium may be transmitted using an appropriate medium, comprising but not limited to wireless, wireline, optical fiber cable, RF, etc., or any suitable combination of the foregoing.

Computer program code for carrying out operations for aspects of the present disclosure may be written in a combination of one or more programming languages, comprising an object oriented programming language such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider) or in a cloud computing environment or offered as a service such as a Software as a Service (“SaaS”).

Aspects of the present disclosure are described herein with reference to flowchart illustrations and/or block diagrams of methods, apparatuses (e.g., systems), and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that, when executed, may direct a computer, other programmable data processing apparatus, or other devices to function in a particular manner, such that the instructions, when stored in the computer readable medium, produce an article of manufacture comprising instructions which, when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices to produce a computer implemented process, such that the instructions which execute on the computer or other programmable apparatus provide processes for implementing the functions/acts specified in the flowchart and/or block diagram block or blocks.

While certain example systems and methods disclosed herein may be described with reference to infrastructure management, systems and methods disclosed herein may be related to other areas beyond network infrastructure. Systems and methods disclosed herein may be related to, and used by, any predictive system that utilizes expert learning or other predictive methods. Systems and methods disclosed herein may be applicable to a broad range of applications that, such as, for example, research activities (e.g., research and design, development, collaboration), commercial activities (e.g., sales, advertising, financial evaluation and modeling, inventory control, asset logistics and scheduling), IT systems (e.g., computing systems, cloud computing, network access, security, service provisioning), medicine (e.g., diagnosis or prediction within a particular specialty or sub-specialty), and other activities of importance to a user or organization.

Although static password policies exist for creating strong account passwords, they may not have the capability to detect the sensitivity of the information stored in the account. The failure to detect the sensitivity of the information stored in the account may lead to strict password requirements to protect little to no sensitive information.

In view of the foregoing, a need has arisen for ways to make dynamic policy changes based on user information to provide frictionless logging for users with less sensitive data, but also adding enough friction for users with more sensitive data.

A user may have many accounts, such as an online account to access their bank and an account with Amazon or other online store. Each account may allow a user to store different types of information. Upon registering for or enrolling in an account, a user is generally required to input at least some minimal amount of information. According to the present invention, at an initial stage, when there is less sensitive information stored in the account, users will be allowed to create and keep a very simple password. When the user adds more sensitive data to his account, the user will be asked to increase password strength. Each time the user adds more information or removes information, a sensitivity test may be performed. Based on a sensitivity score, the user may be asked to increase or decrease password strength according to the sensitivity score. Every time when user adds more data or removes data, the password policy will then be checked, and password strength will be increased or decreased, according to the level of sensitivity of the information stored in the account.

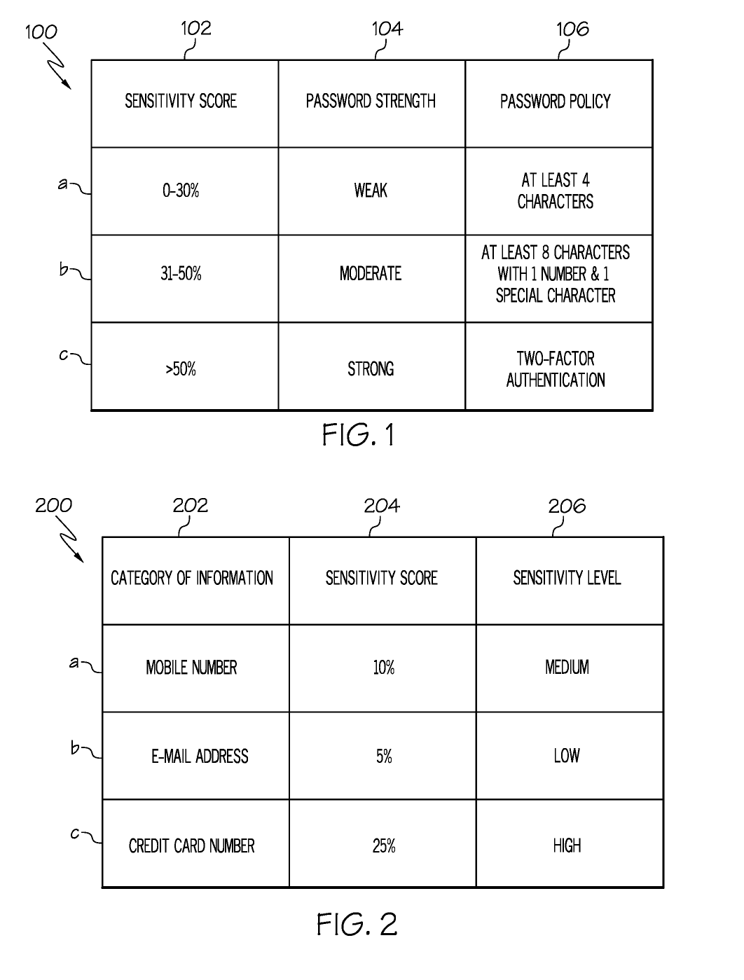

An example embodiment of the present invention may include a dynamic flow of password policies for an account, where the policies are dependent upon the level or score of sensitivity of user information. For example, as depicted in FIG. 1, a sensitivity score between 0 and 30 may require a low strength password, a sensitivity score between 30 and 50 may require a medium strength password, and a sensitivity score greater than 50 may require a high strength password. In an example embodiment, a user's current account sensitivity score may be 28. The user may then add some data or information to the account, and the added data or information may have a sensitivity value of 3, bringing the user's account sensitivity score to 31. In the case of a password policy flow based on numerical value of sensitivity score, the user may be prompted to create a medium level password. The user may then delete some information from the account that has a sensitivity value of 5, bringing the user's account sensitivity score to 26. In the case of a static flow password policy, the user may then be prompted to create a low level password. The above-described three levels of password strength are an example, but are not limited to three levels of password strength. There may be any suitable number of levels of password strengths defined by the user or the server supporting the account. The ranges of sensitivity scores are also an example and may be any suitable range of scores defined by the user or the server supporting the account.

In the case of a dynamic flow password policy, the numerical sensitivity score may not be the only deciding factor because the data elements may also be divided into levels of sensitivity. For example, as depicted in FIG. 2, e-mail id, name, and a transaction below $20 may be categorized as less sensitive personal information (PI), a transaction between $20 and $100 and user preferences may be categorized as moderately sensitive PI, and credit card details and user's mobile number may be categorized as highly sensitive PI. These are merely examples of types of user information which may be stored in the account and the user may add any suitable information to the account. The assigned sensitivity levels are also examples and user information may be assigned any suitable sensitivity level. The levels of sensitivity may be assigned to each type of data or information by a server or from user feedback or input. As in the above example, if the newly added data having a score of 3 is categorized as less sensitive PI, then even after the total account sensitivity score becomes 31, the password policy band requirements may not change, so long as there is still no moderately sensitive data present, for the sensitivity levels based dynamic policy change (i.e., if all the user information is categorized as less sensitive PI, the password policy may not change from low to medium even if the numerical sensitivity score falls within the range of scores for the medium band).

In another example embodiment, a current or baseline user sensitivity score may be 10. This current or baseline sensitivity score may be based on historic account information input by the user when initially setting up the account. The user may then add credit card details to the account. The credit card details may be assigned a score of 15, bringing the total account score to 25. In the case of a password policy based on numerical value of the sensitivity score, the password policy would still only require a low strength password because the numerical sensitivity score falls within the range of scores for the low password strength band. However, in the example case of a dynamic flow password policy, the password policy requirements may be upgraded to next band or to the band that corresponds to the band or level of the highest sensitive data information present in that account (in the example, the band of the credit card number). Since credit card information may be assigned to the highly sensitive level, as in the above example, the password policy may prompt the user to create a password with high strength requirements. This decision may be left up to the implementer. A dynamic flow may consider score, types of data elements, etc. rather than just one factor in determining the appropriate password policy strength requirements. Adding credit cards details is an example of information that may be added to an account but a user may add any suitable information to the account.

Password strength may be categorized into bands, as depicted in the example of FIG. 1. In an example embodiment, password strength may be categorized into 3 bands: weak, moderate, strong. Weak password strength, Band A, may correspond to a sensitivity score of 0-30%. The password policy for Band A may be that the password be at least 4 characters. Moderate password strength, Band B, may correspond to a sensitivity score of 31-50%. The password policy for Band B may be that the password be at least 8 characters and have 1 number and 1 special character. Strong password strength, Band C, may correspond to a sensitivity score greater than 50%. The password policy for Band C may require two-factor authentication. The above password requirements for each Band are examples and the requirements for passwords may be any suitable requirements set by the server/system. The number of Bands may also be any suitable number as defined by the requirements of the server/system. The range of sensitivity scores assigned to each Band may also be any suitable range of scores as defined by the requirements of the server/system.

In an example embodiment, a user may be asked for only bare minimum or baseline data during enrollment or registration for an account. For example, minimum or baseline data may be name, e-mail id, or location. These types of information are generally not very sensitive, and as such the sensitivity score may be lower and initially the password strength may be automatically set to low/weak. In this example, as depicted in FIG. 2, each type of user information may be assigned an individual sensitivity score. For example, mobile number may be assigned a 10% sensitivity score, e-mail id may be assigned a 5% sensitivity score, and credit card details may be assigned a 25% sensitivity score. Whenever a user logs into the account the user may add additional information. If a user adds any sensitive information, like credit card details, then the user may be asked to increase the password strength. A user may later remove information from the account and may be prompted to decrease the password strength if the sensitivity level decreases or the sensitivity score falls into a lower band. The sensitivity score assigned to types of user information may be predetermined according to user preferences or by the server/system preferences. Mobile number, e-mail id, and credit card details are examples of user information, but types of user information are not limited to the foregoing as user information may be any suitable information the user may enter into an account. The password strength requirements depicted in the example embodiment of FIG. 1 may also be used to correspond to the low (weak), medium (moderate), and high (strong) sensitivity levels of user information.

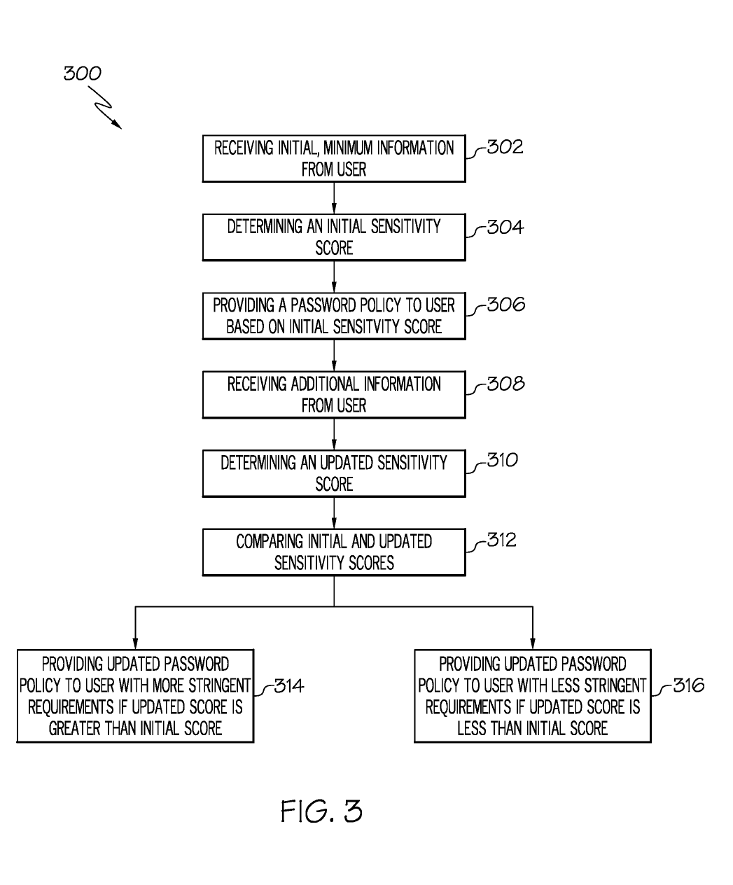

Referring now to FIG. 3, a flow diagram of a process 300 for changing a password policy based on sensitivity level of user information in the account is depicted. At step 302, initial, minimum information is received from a user. An initial sensitivity score is determined based on the sensitivity score or sensitivity level of the initial, minimum information at step 304. At step 306, the user is prompted to create a password by providing the user with a password policy governing the requirements for the password, and the requirements will be based on the initial sensitivity score. The user then provides additional information that is received by the server supporting the account at step 308. At step 310, an updated sensitivity score is determined based on the newly added information. The updated sensitivity score can be determined by adding up individual sensitivity scores of each type of information added to the account and determining a total sensitivity score for the types of information. The updated sensitivity score may also be determined by identifying the highest sensitivity level assigned to a type of information added to the account and having the updated sensitivity score correspond to the highest sensitivity level.

At step 312, the initial and updated sensitivity scores or levels are compared. If the updated sensitivity score or level is greater than the initial sensitivity score, at step 314, the user may be prompted to update the password and may be provided with a password policy which will have more stringent requirements for the password, resulting in increased password strength. A user may also delete or remove information from the account. If the user removes sensitive information from the account, then the updated sensitivity score may be lower than the initial sensitivity score. If the updated sensitivity score is lower than the initial sensitivity score, at step 316, the user may be prompted to update the password and may be provided with a password policy which will have less stringent requirements for the password, resulting in decreased password strength. The addition and removal of information, and subsequent determining and comparing of sensitivity scores, may be repeated multiple times, whenever a user may add or remove information from an account.

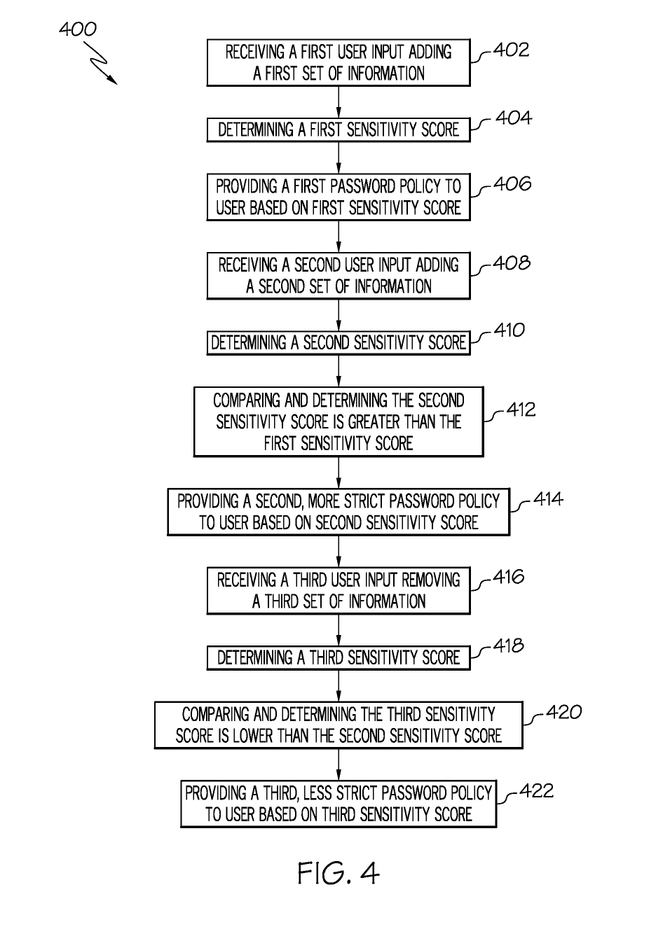

Referring now to FIG. 4, a flow diagram of a process 400 for changing a password policy based on sensitivity level of user information in the account is depicted. At step 402, a first user input is received and the user may be adding a first set of information. The first set of information may be minimal information required for registration or enrolling in an account with an organization, such as a bank or Amazon. The first set of information may be any suitable number of pieces of user information. At step 404, a first sensitivity score is determined based on the type(s) of information in the first set of information. The first sensitivity score may be determined by totaling the numerical sensitivity score(s) of the individual type(s) of information in the first set of information. At step 406, the user is provided with a first password policy, which may define the requirements for the password the user is creating. The requirements may be based on the first sensitivity score, i.e., if the first sensitivity score falls within the low band, the user may be provided with password requirements resulting in a password of weak strength. A second user input is received adding a second set of information at step 408. The second set of information may be one or multiple types and pieces of information. At step 410, a second sensitivity score is determined based on the information now contained in the user's account after receiving the second set of information.

At step 412, the first sensitivity score is compared to the second sensitivity score and it may be determined that the second sensitivity score is greater than the first sensitivity score, and brings the sensitivity score into a higher band of sensitivity. For example, the second sensitivity score may bring the score into the highest level of sensitivity which requires strong password strength. At step 414, the user is provided with a second password policy with more strict requirements than the initial password policy and the requirements are based on which band the second sensitivity score falls within. A third user input is then received which removes a third set of information from the user's account details at step 416. The third set of information may involve removing one or multiple pieces of information from the user's account. At step 418, a third sensitivity score is determined based on the information remaining in the user's account after the third set of information was removed. At step 420, the second and third sensitivity scores are compared and it may be determined that the third sensitivity score is lower than the second sensitivity score. The third sensitivity score may be enough lower than the second sensitivity score to bring the score down into a lower band. For example, removing the third set of information may result in the score moving from the highest sensitivity band into the medium/moderate sensitivity band. The user is provided with a third, less strict password policy where the requirements are based on the password strength band which the third sensitivity score falls within, at step 422.

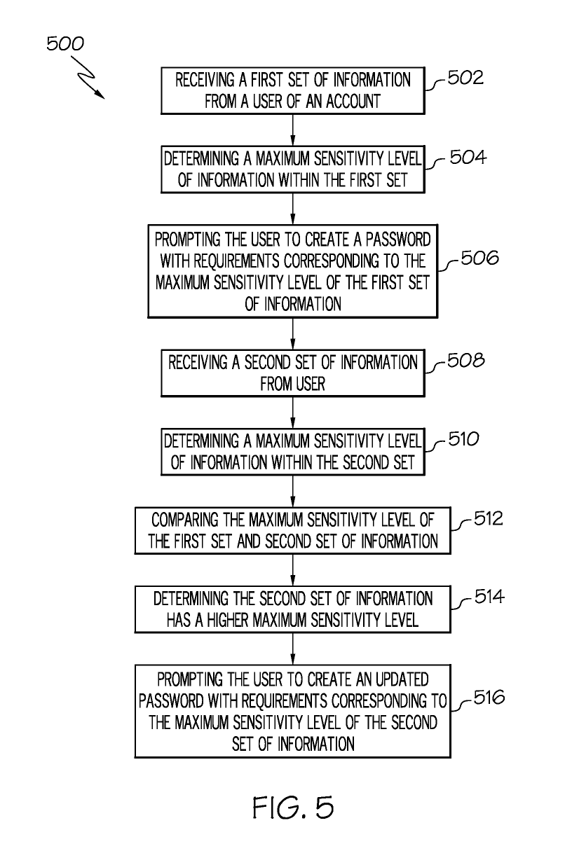

Referring now to FIG. 5, a flow diagram of a process 500 for changing a password policy based on sensitivity level of user information in the account is depicted. At step 502, a first set of information from a user of an account is received by the account. The first set of information may include one or multiple pieces of user information. As described above, each type of user information may be assigned a sensitivity level. At step 504, a maximum sensitivity level of the information within the first set of information is determined. For example, if the first set of information contained one piece of information (e.g., e-mail address) the maximum sensitivity level would be the sensitivity level assigned to the one piece of information (e.g., low). As another example, if the first set of information contained two pieces of information (e.g., e-mail address and mobile number), the maximum sensitivity level would be the highest sensitivity level between the two pieces of information. If e-mail address was assigned low sensitivity level and the mobile number was assigned medium sensitivity level, then the maximum sensitivity level of the first set of information would be medium.

At step 506, the user may be prompted to create a password and the requirements for that password would correspond to the maximum sensitivity level of the first set of information. For example, if the maximum sensitivity level is low, then the password policy would require a weak strength password. At step 508, a second set of information is received from the user. The second set of information may include one or multiple pieces of information. At step 510, a maximum sensitivity level of information within the second set of information may be determined. The maximum sensitivity level of the first set of information and the maximum sensitivity level of the second set of information may be compared at step 512. At step 514, it may be determined that the second set of information has a higher maximum sensitivity level than the first set of information. The user may be prompted to create an updated password with requirements that correspond to the maximum sensitivity level of the second set of information at step 516. For example, if the first set of information had a maximum sensitivity level of low and the second set of information had a maximum sensitivity level of medium, the user would be provided with password requirements in accordance with a password strength of moderate which corresponds to the medium sensitivity level. This type of maximum sensitivity level determination may trump numerical sensitivity score depending on the settings/preferences of the account.

The flowchart and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method, comprising:
receiving a first set of information from a user;
in response to receiving the first set of information, determining a first sensitivity score;
determining whether the first sensitivity score is greater than a baseline sensitivity score, wherein the baseline sensitivity score is based on historic account information from the user and wherein requirements for an historic account password are based on the baseline sensitivity score; and
in response to determining that the first sensitivity score is greater than the baseline sensitivity score, prompting the user to modify the historic account password to create a first password, wherein requirements for the first password are based on the first sensitivity score and require increased strength of the first password relative to the historic account password.

2. The method of claim 1, wherein the historic account information comprises a minimum amount of information to enable user registration or enrollment.

3. The method of claim 1, wherein categories of user information are assigned pre-determined individual sensitivity values.

4. The method of claim 3, further comprising identifying a first category of information corresponding to the historic account information, wherein the baseline sensitivity score corresponds to the individual sensitivity value assigned to the first category of information.

5. The method of claim 4, further comprising identifying a second category of information corresponding to the first set of information received from the user, and
wherein determining the first sensitivity score is based at least in part on the individual sensitivity values for the first category of information and the second category of information.

6. The method of claim 1, further comprising:
receiving a second set of information from the user;
in response to receiving the second set of information, determining a second sensitivity score;
determining whether the second sensitivity score is greater than the first sensitivity score; and
in response to determining that the second sensitivity score is less than the first sensitivity score, prompting the user to modify the first password to create a second password, wherein requirements for the second password are based on the second sensitivity score and require decreased strength of the second password relative to the first password.

7. The method of claim 6, wherein the second set of information comprises deleting user information.

8. A non-transitory computer-readable storage medium, comprising computer-executable instructions carried on the computer-readable storage medium, the instructions readable by a processor and, when read and executed, configured to cause the processor to:
receive a first set of information from a user;
determine a first sensitivity score;
prompt the user to create a first password, wherein requirements for the first password are based on the first sensitivity score;
receive a second set of information from the user;
in response to receiving the second set of information, determine a second sensitivity score;
determine whether the second sensitivity score is greater than the first sensitivity score; and
in response to determining that the second sensitivity score is greater than the first sensitivity score, prompt the user to modify the first password to create a second password, wherein requirements for the second password are based on the second sensitivity score and require increased strength of the second password relative to the first password.

9. The non-transitory computer-readable storage medium of claim 8, wherein the first set of information comprises a minimum amount of information to enable user registration or enrollment.

10. The non-transitory computer-readable storage medium of claim 8, wherein categories of user information are assigned pre-determined individual sensitivity values.

11. The non-transitory computer-readable storage medium of claim 10, wherein the instructions readable by a processor and, when read and executed, are further configured to cause the processor to identify a first category of information corresponding to the first set of information received from the user, wherein the first sensitivity score corresponds to the individual sensitivity value assigned to the first category of information.

12. The non-transitory computer-readable storage medium of claim 11, wherein the instructions readable by a processor and, when read and executed, are further configured to cause the processor to identify a second category of information corresponding to the second set of information received from the user,
wherein determine the second sensitivity score is based at least in part on the individual sensitivity values for the first category of information and the second category of information.

13. The non-transitory computer-readable storage medium of claim 8, wherein the instructions readable by a processor and, when read and executed, are further configured to cause the processor to:
receive a third set of information from the user;
in response to receiving the third set of information, determine a third sensitivity score;
determine whether the third sensitivity score is greater than the second sensitivity score; and
in response to determining that the third sensitivity score is less than the second sensitivity score, prompt the user to modify the second password to create a third password, wherein requirements for the third password are based on the third sensitivity score and require decreased strength of the third password relative to the second password.

14. The non-transitory computer-readable storage medium of claim 8, wherein categories of user information are assigned individual sensitivity levels, wherein the individual sensitivity levels comprise low, medium, or high.

15. A computer system, comprising:
a server configured to:
receive a first set of information from a user;
determine a first sensitivity score;
prompt the user to create a first password, wherein requirements for the first password are based on the determined first sensitivity score;
receive a second set of information from the user;
in response to receiving the second set of information, determine a second sensitivity score;
determine whether the second sensitivity score is greater than the first sensitivity score; and
in response to determining that the second sensitivity score is greater than the first sensitivity score, prompt the user to modify the first password to create a second password, wherein requirements for the second password are based on the second sensitivity score and require increased strength of the second password relative to the first password.

16. The computer system of claim 15, wherein the first set of information comprises a minimum amount of information to enable user registration or enrollment.

17. The computer system of claim 15, wherein categories of user information are assigned pre-determined individual sensitivity values.

18. The computer system of claim 17, wherein the server is further configured to identify a first category of information corresponding to the first set of information received from the user, wherein the first sensitivity score corresponds to the individual sensitivity value assigned to the first category of information.

19. The computer system of claim 18, wherein the server is further configured to identify a second category of information corresponding to the second set of information received from the user,
wherein determine the second sensitivity score is based at least in part on the individual sensitivity values for the first category of information and the second category of information.

20. The computer system of claim 15, wherein the server is further configured to:
receive a third set of information from the user;
in response to receiving the third set of information, calculate a third sensitivity score;
determine whether the third sensitivity score is greater than the second sensitivity score; and
in response to determining that the third sensitivity score is less than the second sensitivity score, prompt the user to modify the second password to create a third password, wherein requirements for the third password are based on the third sensitivity score and require decreased strength of the third password relative to the second password.
